(19) United States
(12) Patent Application Publication
(10) Pub. No.: US 2004/0073667 A1
(43) Pub. Date: Apr. 15, 2004

(54) System and method for providing access to computer program applications

(76) Inventors: Darin E. Hamilton, Creve Coeur, IL (US); Paul C. Barker, Dunlap, IL (US); Francis V. Brady, LaFayette, IL (US); Thomas F. Casey, Morton, IL (US); Patrick M. Hogan, East Peoria, IL (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/269,307

(22) Filed: Oct. 11, 2002

(51) Int. Cl. G06F 15/173

(52) U.S. Cl. 709/225

(57) ABSTRACT

A system and method for provide access to at least one computer program application through a server system to a user. The system and method log the user onto the server system in response to logon information established by the user and associate the user with an organization as a function of the logon information. Access to the at least one computer program application is granted to the user as a function of the organization associated with the user.

### TECHNICAL FIELD

The present invention relates generally to computer program applications, and more particularly, to a system and method for controllably providing access to one or more computer program applications.

### BACKGROUND

Different scenarios exist in which one organization needs or desires to provide access to various computer program applications (which run on an internal system(s)) to external organizations. For example, a company may want or need to grant access to computer program applications to its external suppliers, design houses, contractors, or software licensees.

Access to these computer program applications may be granted using a computer network which connect the company's computers to the outside organization's computers.

Generally access is granted on an application by application basis. That is, each application has its own security application which grants access to designated users. Therefore if one user has access to three different applications, then access has to be permitted for each application. This is typically performed manually and is very time consuming.

One solution has been to utilize pre-configured numerical access levels, e.g., 1-4. Users of these systems are assigned a security access level based on their needs/privileges. Users then have access to the applications based on their assigned access level. This approach is easier to maintain. However, it is inflexible because all users having the same assigned access level have access to the same applications. In other words, it does not allow variations between users with the same access level.

The present invention is aimed at one or more of the problems identified above.

### SUMMARY OF THE INVENTION

In a first aspect of the present invention, a method for providing access to at least one computer program application through a server system to a user is provided. The method includes the steps of logging the user onto the server system in response to logon information established by the user and associating the user with an organization as a function of the logon information. The method also includes the steps of granting access to the at least one computer program application to the user as a function of the organization associated with the user.

In a second aspect of the present invention, a method for providing access to a plurality of computer program applications through a server system to a user is provided. The method includes the steps of logging the user to the server system in response to logon information established by the user and associating the user with an organization as a function of the logon information. The method also includes the step of granting access to one or more of the computer program applications as a function of the organization associated with the user.

In a third aspect of the present invention, A method for providing access to a plurality of computer program applications through a server system to a user includes the steps of logging the user to the server system in response to logon information established by the user, associating the user with an organization as a function of the logon information, and determining access information as a function of the organization associated with the user. The method also includes the steps of determining any overrides as a function of the user and granting access to one or more of the computer program applications as a function of the access information and the overrides associated with the user.

In a fourth aspect of the present invention, a method for providing access to a plurality of computer program applications through a Web server to a user through a Web browser on a client system is provided. The method includes the steps of accessing a Web page by the user using the Web browser and determining if a logon cookie is stored on the client system. If the logon cookie is not stored on the client system, the method performs the steps of requesting logon information from the user and writing the logon cookie to the client system. If the logon cookie is stored on the client system, the method performs the steps of retrieving the logon information from the logon cookie. The method further includes the steps of providing a directory of users and determining if an organization cookie is stored on the client system. If the organization cookie is not stored on the client system, the method performs the steps of establishing an identity of the user as a function of the logon information, querying the directory of users for the organization associated with the user, and writing the organization cookie to the client system. If the organization cookie is stored on the client system, the method performs the steps of determining the organization associated with the user as a function of the organization cookie. The method further includes the steps of determining access information as a function of the organization associated with the user and granting access to one or more of the computer program applications as a function of the access information.

In a fifth aspect of the present invention, a computer program product for providing access to a plurality of computer program applications through a server system to a user is provided. The computer readable program code includes computer readable program code means for logging the user to the server system in response to logon information established by the user, computer readable program code means for associating the user with an organization as a function of the logon information, and computer readable program code means for granting access to one or more of the computer program applications as a function of the organization associated with the user.

In a sixth aspect of the present invention, a computer program product for providing access to a plurality of computer program applications through a server system to a user is provided. The computer readable program code includes computer readable program code means for logging the user to the server system in response to logon information established by the user, computer readable program code means for associating the user with an organization as a function of the logon information, computer readable program code means for determining access information as a function of the organization associated with the user, computer readable program code means for determining any overrides as a function of the user, and computer readable program code means for granting access to one or more of the computer program applications as a function of the access information and the overrides associated with the user.

In a seventh aspect of the present invention, a system for providing access to at least one computer program application to a user is provided. The system includes a client system for allowing the user to logon to the system by establishing logon information and a server system, coupled to the client system by a communication channel, for receiving the logon information from the client machine, associating the user with an organization as a function of the logon information, and granting access to one or more of the computer program applications as a function of the organization associated with the user.

### BRIEF DESCRIPTION OF THE DRAWINGS

FIG. 1 is a block diagram of a system for providing access to one or more computer program applications to a user, according to an embodiment of the present invention;

FIG. 2 is a flow diagram of a method for providing access to one or more computer program applications to a user, according to an embodiment of the present invention;

FIG. 3 is a flow diagram of a method for providing access to one or more computer program applications to a user, according to another embodiment of the present invention;

FIG. 4 is a block diagram of a computer program product for providing access to one or more computer program applications to a user, according to an embodiment of the present invention;

FIG. 5 is a block diagram of a computer program product for providing access to one or more computer program applications to a user, according to another embodiment of the present invention; and,

FIG. 6 is a flow diagram of a method for providing access to one or more computer program applications to a user, according to another embodiment of the present invention.

### DETAILED DESCRIPTION

With reference to the drawings and in operation, the present invention provides a system 10, method 40, 50, 60, and a computer program product 70, 80 for providing access to at least one computer program application.

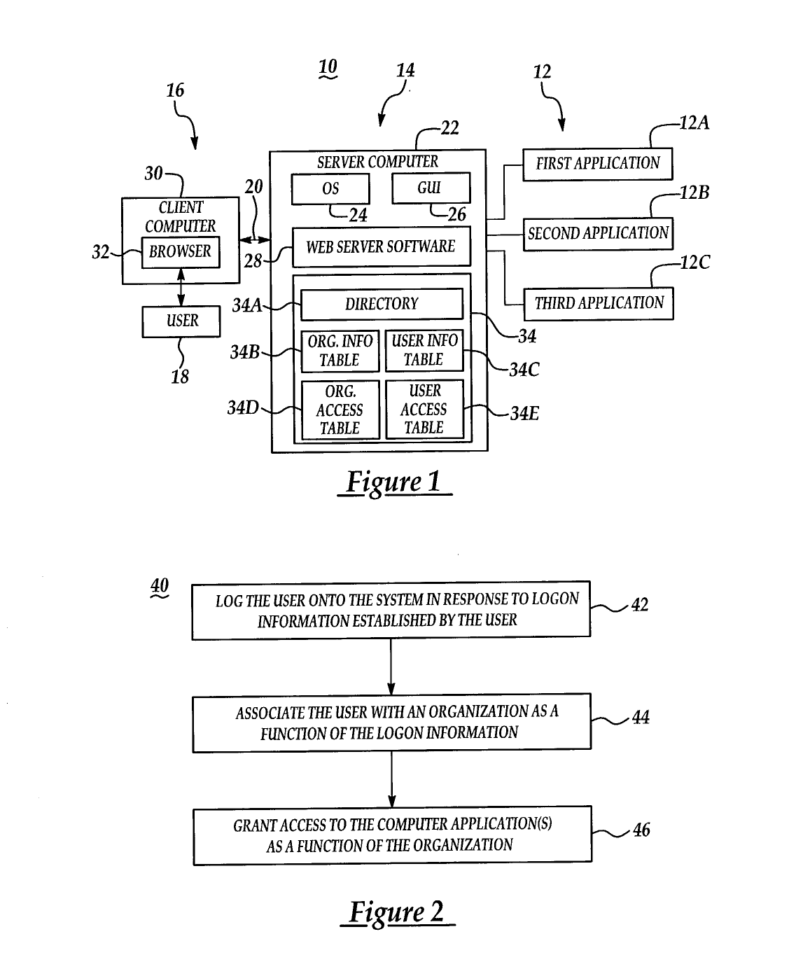

With specific reference to FIG. 1, the system 10 provides access to a plurality of computer program applications 12. In the illustrated embodiment, the computers applications includes first, second, and third computer program applications 12A, 12B, 12C, although, the present invention may be adapted to provide access to any number of computer program applications.

In the illustrated embodiment, the system 10 utilizes a server/client structure. A server system 14 is coupled to the computer program applications 12. A client system 16 is coupled to the server system 14. A user 18 accesses the system 10 through the client system 16. The client system 16 is connected to the server system by a communications link 20 which may be a computer network, such as, a LAN, wide area network (WAN), virtual private network (VPN), the internet, or any other suitable communications link. Also, although only one client system 16 is shown, the system 10 may include any number of client systems 16 which provide access to the system 10 to a plurality of users 18.

The computer program applications may be any type of computer program applications, such as a web-based computer program application and/or hosted applications, i.e., mainframe applications which are “hosted” by the system 10. A computer program application 12 may actually be implemented on the server system 14 or may be implemented on another system (not shown), such as a mainframe system. For example, a mainframe computer program application may be implemented on a mainframe computer (not shown). Access to the mainframe application may be granted to a user and “hosted” by the server system 14 via “host” software.

In the illustrated embodiment, the system 10 includes one or more server computers 22. In the illustrated embodiment, the system 10 is web-based. A suitable server computer or platform includes an IBM RISC System/6000 computer 22 running the Advanced Interactive Executive (AIX) operating system 24 and a Web server program 26, such as Netscape Enterprise Version 2.0. The server computer 22 also includes a graphical user interface (GUI) 28 for management and administration. Other hardware/software combinations may also be used.

The client system 16 includes at least one client computer 30. In the illustrated embodiment, the client computer 30 is coupled to the server system 16 via the communications link 20. In one embodiment, the client computer 30 may be any computer connected to the communications link 20 and on which runs a suitable web browser 32.

In one aspect of the present invention, the user 18 logs onto the system 10 by establishing logon information via the client computer 30. The server system 14 receives the logon information from the client machine 16, associates the user 18 with an organization as a function of the logon information, and grants access to one or more of the computer program applications 12 as a function of the organization associated with the user 18. In the illustrated embodiment, the user 18 accesses the system 10 by invoking an universal resource locator (URL) address via a web browser 32 on the client computer 30.

The server system 14 includes a database 34 which includes information related to the organizations which have access to the system 10 and may also include information related to individual users.

Each organization may be granted access to one or more of the computer program applications 12. Each organization may have associated with it, one or more authorized users 18. As described below, the computers applications 12 to which each organization has access and the users 18 associated with each organization is contained within the database 34. As more fully described below, when the user 18 logs onto the system 10, the user 18 is associated with an organization and computer program applications 12 to which the user 18 is granted access is determined as a function of the associated organization.

The database 34 may be comprised of a single database file or may be comprised of different files in different formats. For example, in one embodiment, the database 34 may include a directory of users 34A. The directory of users 34A may contain a list of all users 18 of the system 10 and their associated organizations. In one embodiment, the directory of users 34A may be a database which already exists. In another embodiment, the directory 34A may be a table in a relational database file.

In the illustrated embodiment, the database 34 also includes a system table 34B, an organization information table 34C, a user information table 34D, an organization access table 34E, and a user access table 34F. The directory and tables 34A-34F may be contained in single or multiple files. Other tables may also be included for operation of the system 10. The purpose and contents of each table 34A-34F will be discussed more fully below.

The server system 14 may establish an identity of the user 18 as a function of the logon information and queries the directory 34A for the organization associated with the user 18.

In one embodiment, the logon information, e.g., a user id and password, is entered by the user 18 through a logon screen (not shown) implemented on the browser 32. Once the user 18 is logged onto the system 10, the server system 14 access the directory 34A to determine with which organizations the user 18 is associated.

In another embodiment, the logon information may be contained within a logon cookie stored on the client computer 30. Cookies are a known internet mechanism in which information can both be stored and retrieved. A cookie may contain both the user id and the password and the address(es) for which the user id and password are valid.

In still another embodiment, the system 10 first determines if a logon cookie is stored on the client computer 30. The user 18 accesses the system by addressing a specific URL address for the system 10. If the cookie exists or is stored on the client computer 30, then the logon information is retrieved from the cookie.

If the logon cookie does not exist, then the web browser 32 is directed towards a logon screen (not shown) which instructs the user 18 to enter their logon information. After the logon information is entered, a logon cookie may be written to the client computer 30.

In another aspect of the present invention, the server system 14 may also determine if an organization cookie is stored on the client system 16. The organization cookie may contain the organization to which the user 18 is associated. If the organization cookie exists, the server system 14 may retrieve the organization with which the user is associated from the organization cookie.

If the organization cookie does not exist, the server 14 may retrieve the associated organization by looking up the user 18 in the directory 34A. After the associated organization is found, the organization cookie containing the associated organization may be written to the client computer 30.

As discussed above, the server system 14 determines which of the computer program applications 12 the user 18 has access as a function of the organization with which the user 18 is associated. In other words, each organization has been granted access to one or more of the computer program applications 12. A user 18 associated with an organization is automatically granted (or automatically inherits) access to the same computer program application(s) 12 to which the organization has been granted access.

As discussed above, the database 34 may include an organization information table 34B, a user information table 34C, an organization access table 34D, and a user access table 34E. In one embodiment, these tables 34B, 34C, 34D, 34E contain the following information, respectively:

organization information table 34B: information related to each organization, such as, an organization code, location, street address, city, and phone number;

user information table 34C: contains a list of users 18 which have an entry on the user access table 34E;

organization access table 34D: contains an entry for each organization and whether an organization has access to each computer program application 12; and,

user access table 34E: contains any overrides associated with any user 18, i.e., changes for a specific user 18 to the default access of the associated organization In one embodiment, if no overrides exist for a user, then the user is not listed in the user access table 34E.

In one embodiment, the server system 14 determines access information as a function of the organization associated with the user 18 and grants access to one or more computer program applications 12 as a function of the access information. In one embodiment, the access information includes the access status for each computer program application 12, i.e., whether the users 18 associated with the organization have access to each computer program application 12. Alternatively, the organization access table 34D may include, for each organization, a list of those applications to which the organization has access. In another embodiment, the access information may be time limited. In other words, the users 18 associated with an organization may have access to a particular computer program application for a limited period of time. For example, the organization's license to a computer program application may be only for a particular use or for a limited time period.

In another embodiment, the server system 14 queries the user access table 34E as a function of the identity of the user 18 and establishes any access overrides for the user 18. The server system 14 may then grant access to one or more computer program applications 12 as a function of the access information and any access overrides associated with the user 18. An override may either add access to one or more applications (expand access) or remove access to one or more applications (contract access).

With reference to FIG. 2 in another aspect of the present invention, a method 40 for providing access to one or more computer program applications 12 to a user 18 is provided. In a first process step 42, the user 18 is logged onto the system in response to logon information, e.g., user id and password, established by the user 18. In a second process step 44, the organization with which the user 18 is associated is determined as a function of the logon information. In a third process step 46, access to one or more of the computer program applications 12 is granted to the user 18 as a function of the organization associated with the user 18.

In one embodiment of the present invention, the method 40 includes the step of providing a directory of users 34A. Each user 18 in the directory 34A is associated with an organization. The method 40 may also include the steps of establishing an identity of the user as a function of the logon information and querying the directory 34A for the organization associated with the user 18.

In one embodiment, the step of logging the user onto the server system includes the steps of accessing a web page stored on the server system 14 and determining if a logon cookie is stored on the client system 16. If the logon cookie is stored on the client system 16, then the method retrieves the logon information from the logon cookie. If the logon cookie is not stored on the client system 16, then the method routes the user 18 to a logon screen (not shown) and requests that the user 18 enter the logon information. Furthermore, the logon cookie may be written to the client system 16.

The method 40 may also include the steps of determining if an organization cookie is stored on the client system. If the organization cookie is stored on the client system 16, then the method 40 retrieves the organization with which the user 18 is associated from the organization cookie. If the organization cookie is not stored on the client system 16, then the method 40 performs the step of querying the directory 34A for the organization associated with the user 18.

Furthermore, the method 40 may include the step of writing the organization cookie to the client system 16.

In one embodiment, the step of granting access to the one or more computer program applications 12 includes the step of determining access information as a function of the organization associated with the user 18. Furthermore, the step of granting access to the computer program application 12 may include the step of granting access to the computer program application(s) 12 as a function of the access information.

In another embodiment, the method 40 includes the step of querying the user access table as a function of the user 18 and establishing any access overrides for the user. The method 40 may further include the step of granting access to the computer program application as a function of the access information and any access overrides associated with the user 18.

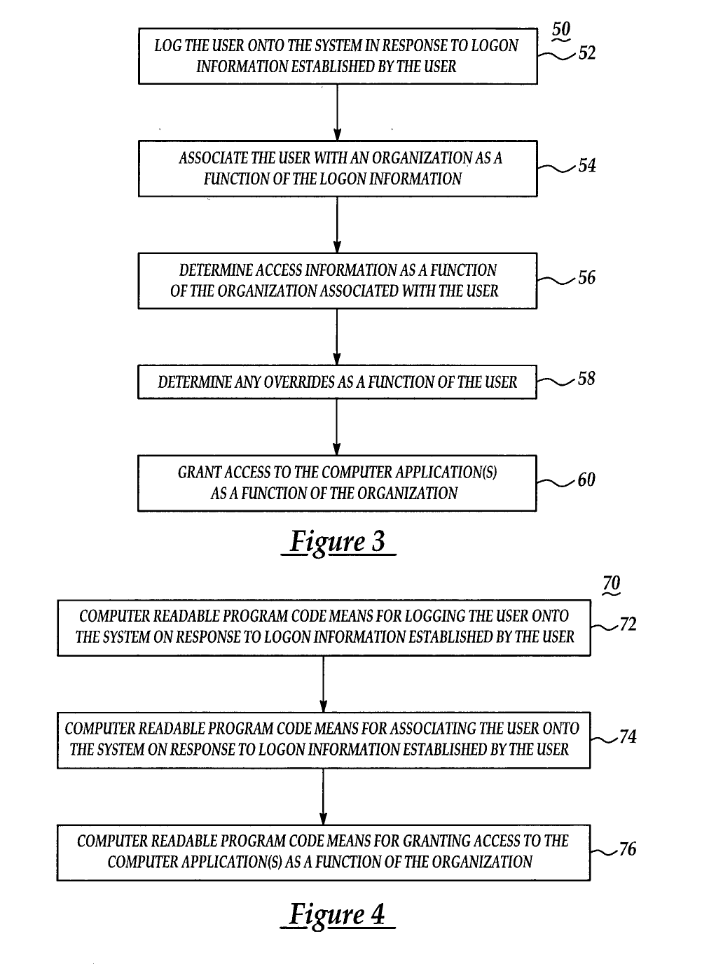

With reference to FIG. 3 in another aspect of the present invention, a method 50 for providing access to a plurality of computer program applications 12 through to the user 18 is provided. In a first process step 52 the user is logged onto a server system 14 in response to logon information established by the user 18. In a second process step 54, the user is associated with an organization as a function of the logon information. In a third process step 56, access information is determined as a function of the organization associated with the user 18. In a fourth process step, any overrides associated with the user 18 are determined. In a fifth process step, access to one or more of the computer program applications is granted as a function of the access information and the overrides associated with the user 18.

With reference to FIG. 4, in another aspect of the present invention, a computer program product 70 for providing access to a plurality of computer program applications 12 to a user 18 is provided. The computer program product 70 includes computer readable program code means 72 for logging on the user 18 in response to logon information established by the user 18, computer readable program code means 74 for associating the user 18 with an organization as a function of the logon information, and computer readable program code means 76 for granting access to one or more of the computer program applications 12 as a function of the organization associated with the user 18.

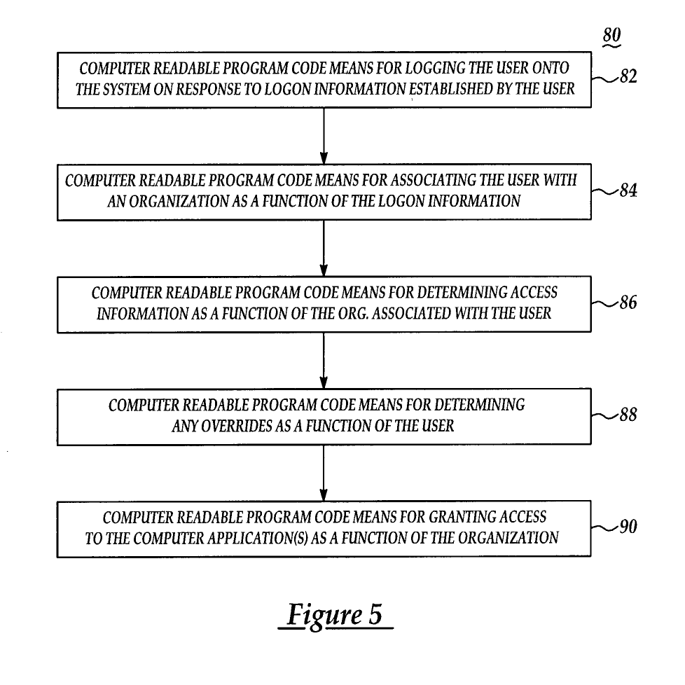

With reference to FIG. 5, in another aspect of the present invention, a computer program product 80 for providing access to a plurality of computer program applications 12 to a user is provided. The computer program product 80 includes computer readable program code means 82 for logging on the user 18 in response to logon information established by the user 18, computer readable program code means 84 for associating the user 18 with an organization as a function of the logon information, computer readable program code means 86 for determining access information as a function of the organization associated with the user 18, computer readable program code means 88 for determining any overrides as a function of the user 18, and computer readable program code means 90 for granting access to one or more of the computer program applications 12 as a function of the access information and the overrides associated with the user 18.

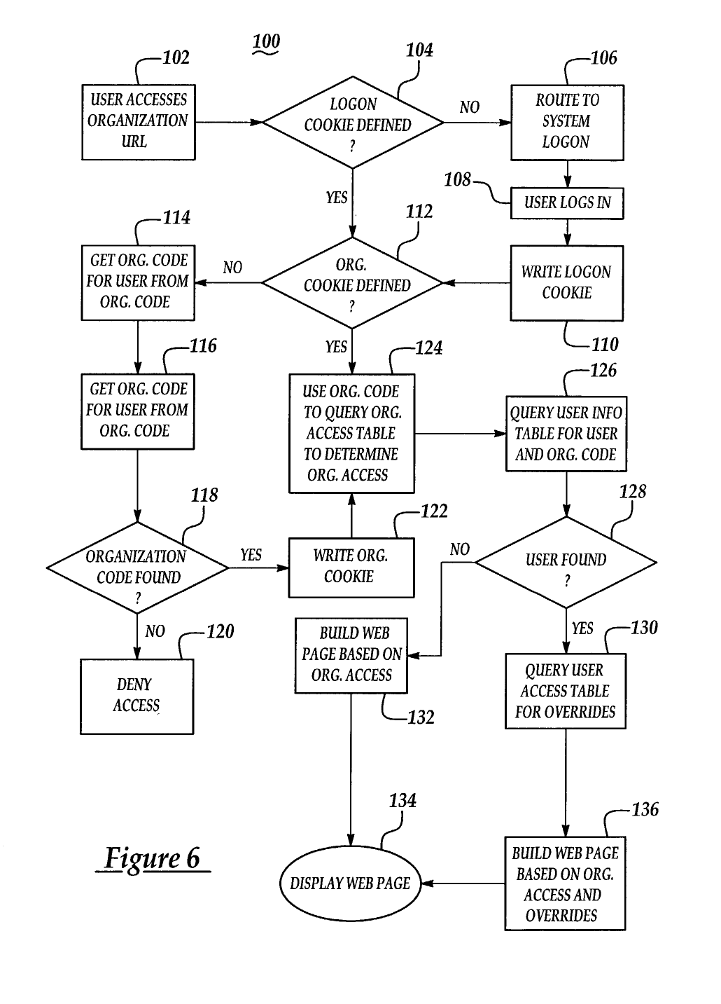

With specific reference to FIG. 6, in still another aspect of the present invention, a method 100 for providing access to a plurality of computer program applications 12 through a Web server 22 to a user 18 through a Web browser 32 on a client system 16 is provided. In a first process step 102, the user 18 accesses or invokes the system 10 by accessing a Web page using the Web browser 32. In a first decision step 104, the method 100 determines if a logon cookie is stored or defined on the client system 16. If the logon cookie is not stored on the client system 16, then the method 100 proceeds to a second process step 106. In the second process step 106, the method 100 is routed to a system logon and the user logs in (in a third process step 108). In a fourth process step 110, the logon cookie is written to the client system 16.

If in the first decision step 104, the logon cookie was defined, the method 100 proceeds to a second decision step 112. In the second decision step 112, if a organization cookie is not defined, then the method 100 proceeds to a fifth process step 114. In the fifth process step, the user (as identified by the logon information from the logon cookie or entered by the user 18), is looked up in the directory 34A and an access code for the associated organization is determined. The organization is then searched in the organization information table 34B to determine additional information related to the organization, such as name, address, and email address information. In a third decision step 119, if an organization code was not found then the method 100 proceeds to a seventh process step 120. In the seventh process step 120, access to the system 10 is denied.

If an organization code was found, then the method 600 proceeds to an eighth process step 122. In the eighth process step 122, the organization cookie containing the organization code is written to the client system 16. In a ninth process step 124, the organization access table 34D is queried using the organization code to determine the access (access information) associated with the organization using the organization code.

In a tenth process step 126, the user information table 34C is queried to determine (as a function of the user) if the user 18 has an entry in the user access table 34E. The user access table 34E contains any overrides associated with the user 18.

In a fourth decision step 128, if the user 18 has been found in the user information table 34C, then the method 100 proceeds to an eleventh process step 130. Otherwise, the method 100 proceeds to a twelfth process step 132.

In the twelfth process step 132, a web page is built and displayed (in a thirteenth process step 134) via the browser 32 which contains links to access the computer program applications 12 as a function of the access information associated with the organization code.

In the eleventh process step 130, the user access table 34E is queried as a function of the user 18 to determine to determine the overrides associated with the user 18. In a fourteenth process step 136, a web page is built which contains links to access the computer program applications 12 as a function of the access information associated with the organization code and any overrides associated with the user 18.

In one aspect of the present invention, the web page is built dynamically and may include a navigation bar on the left side which includes links to each of the computer program applications 12 to which the user 18 has access.

Additional links may be provided in a center of the web page. Links which reference computer program applications to which the user 18 does not have access may also be provided. In one embodiment, these links may be provided along the bottom of the web page. In one aspect of the present invention, selection of one of these additional links may give information to the user 18, e.g., on how to obtain access to the given computer program application, an overview of the computer program application, and/or an advertising for the corresponding computer program application 12.

Industrial Applicability

With reference to the drawings, the present invention provides a system 10, method 40, 50, 100 and computer program product 70, 80 for providing access to one or more computer program applications 12 to users at different organizations.

For example, a manufacturing company may provide access to various computer program applications to its suppliers or contractors. The computer program applications 12 may be related to the work or products provided by the suppliers. Access may be granted to the supplier as a result of the nature of the work or products provided or may be provided under a license (with or without a license fee) to the supplier. The suppliers may have access to or may have licensed different ones of the computer program applications provided by the manufacturer.

The computer program applications 12 may include, but are not limited to programs for providing access to a parts catalog, for providing access to engineering drawings, for exchanging information, for invoicing or payments (e.g., e-commerce applications), for providing email communications, for performing engineering analysis, etc . . . .

Besides access to applications which may be provided as a result of the work or products being provided, the organization or supplier may purchase a license to a computer program application 12. Depending on the license, the access to the computer program application may be limited in time and the system 10 may automatically cut off access after a defined time period lapsed.

When a user 18 logs onto the system 10, the system 10 identifies the user 18 and determines an organization associated with the user 18.

In one aspect of the present invention, access information, which defines the computer program applications to which the system 10 will grant access to the user 18, is defined solely or initially based on the associated organization. In other words, the system 10 does not need to store access information for each user 18 of the system. The system 10 stores in the database 34, the access information for each organization and the organization to which each user is associated.

In another aspect of the present invention, the system 10 allows for exceptions to the access defined for each organization. In other words, the computer program applications to which a user 18 has access are defined initially by the associated organization. The system 10 may then determined whether any exceptions or overrides exist for the user 18, e.g., whether the user 18 has access to additional computer program applications or the user 18 does not have access to a computer program application to which other users 18 associated with the organization do have access. The initial access is then modified by the overrides or exceptions defined for the user 18.

Other aspects and features of the present invention can be obtained from a study of the drawings, the disclosure, and the appended claims.

What is claimed is:

1. A method for providing access to at least one computer program application through a server system to a user, including:
logging the user onto the server system in response to logon information established by the user;
associating the user with an organization as a function of the logon information;
granting access to the at least one computer program application to the user as a function of the organization associated with the user.

2. A method, as set forth in claim 1, including the step of providing a directory of users, each user in the directory being associated with an organization.

3. A method, as set forth in claim 2, wherein the step of associating the user with an organization includes the steps of:
establishing an identity of the user as a function of the logon information; and,
querying the directory of users for the organization associated with the user.

4. A method, as set forth in claim 2, wherein the directory of users is maintained in a database.

5. A method, as set forth in claim 4, wherein the database is a relational database.

6. A method, as set forth in claim 1, wherein the logon information is entered by the user.

7. A method, as set forth in claim 1, wherein the user establishes the logon information using a client system connected to the server system.

8. A method, as set forth in claim 7, wherein the step of logging the user onto the server system includes the steps of:
accessing a web page stored on the server system by the user;
determining if a logon cookie is stored on the client system; and,
if the logon cookie is stored on the client system, retrieving the logon information from the logon cookie.

9. A method, as set forth in claim 8, if the logon cookie is not stored on the client system, performing the step of requesting the logon information from the user.

10. A method, as set forth in claim 9, including the step of writing the logon cookie onto the client system.

11. A method, as set forth in claim 7, including the steps of:
determining if an organization cookie is stored on the client system; and,
if the organization cookie is stored on the client system, retrieving the organization with which the user is associated from the organization cookie.

12. A method, as set forth in claim 11, including the step of providing a directory of users, the directory including an organization associated with each user, if any, and if the organization cookie is not stored on the client system, then performing the step of querying the directory of users for the organization associated with the user.

13. A method, as set forth in claim 12, including the step of writing the organization cookie to the client system.

14. A method, as set forth in claim 1, wherein the step of granting access to the computer program application includes the step of determining access information as a function of the organization associated with the user.

15. A method, as set forth in claim 14, wherein the step of granting access to the computer program application further includes granting access to the computer program application as a function of the access information.

16. A method, as set forth in claim 15, further including the steps of:
providing a user access table, the user access table containing any access overrides for the users; and,
querying the user access table as a function of the user and establishing any access overrides for the user.

17. A method, as set forth in claim 16, wherein the step of granting access to the computer program application further includes granting access to the computer program application as a function of the access information and any access overrides associated with the user.

18. A method for providing access to a plurality of computer program applications through a server system to a user, including:
logging the user to the server system in response to logon information established by the user;
associating the user with an organization as a function of the logon information; and,
granting access to one or more of the computer program applications as a function of the organization associated with the user.

19. A method, as set forth in claim 18, including the step of providing a directory of users, the directory including an organization associated with each user, if any.

20. A method, as set forth in claim 19, wherein the step of associating the user with an organization includes the steps of:
establishing an identity of the user as a function of the logon information; and,
querying the directory of users for the organization associated with the user.

21. A method, as set forth in claim 19, wherein the directory of users is maintained in a database.

22. A method, as set forth in claim 21, wherein the database is a relational database.

23. A method, as set forth in claim 18, wherein the logon information is entered by the user.

24. A method, as set forth in claim 18, wherein the user establishes the logon information using a client system connected to the server system.

25. A method, as set forth in claim 24, wherein the step of logging the user onto the server system includes the steps of:
accessing a web page stored on the server system by the user;
determining if a logon cookie is stored on the client system; and,
if the logon cookie is stored on the client system, retrieving the logon information from the logon cookie.

26. A method, as set forth in claim 25, if the logon cookie is not stored on the client system, performing the step of requesting the logon information from the user.

27. A method, as set forth in claim 26, including the step of writing the logon cookie onto the client system.

28. A method, as set forth in claim 24, including the steps of:
determining if an organization cookie is stored on the client system; and,
if the organization cookie is stored on the client system, retrieving the organization with which the user is associated from the organization cookie.

29. A method, as set forth in claim 28, including the step of providing a directory of users, the directory including an organization associated with each user, if any, and if the organization cookie is not stored on the client system, then performing the step of querying the directory of users for the organization associated with the user.

30. A method, as set forth in claim 29, including the step of writing the organization cookie to the client system.

31. A method, as set forth in claim 18, including the steps of providing a user access table, the user access table including any access overrides associated with the users.

32. A method, as set forth in claim 18, wherein the step of granting access to one or more of the computer program applications includes the step of determining access information as a function of the organization associated with the user.

33. A method, as set forth in claim 32, wherein the step of granting access to the one or more computer program applications further includes granting access to the one or more of the computer program applications as a function of the access information.

34. A method, as set forth in claim 19, further including the steps of:
providing a user access table, the user access table containing any access overrides for the users; and,
querying the user access table as a function of the user and establishing any access overrides for the user.

35. A method, as set forth in claim 34, wherein the step of granting access to the one or more computer program applications further includes granting access to the computer program application as a function of the access information and any access overrides associated with the user.

36. A method for providing access to a plurality of computer program applications through a server system to a user, including:
logging the user to the server system in response to logon information established by the user;
associating the user with an organization as a function of the logon information;
determining access information as a function of the organization associated with the user;
determining any overrides as a function of the user; and,
granting access to one or more of the computer program applications as a function of the access information and the overrides associated with the user.

37. A method for providing access to a plurality of computer program applications through a Web server to a user through a Web browser on a client system, including:
a. accessing a Web page by the user using the Web browser;
b. determining if a logon cookie is stored on the client system;
c. if the logon cookie is not stored on the client system, performing the steps of:
1. requesting logon information from the user; and
2. writing the logon cookie to the client system;
d. if the logon cookie is stored on the client system, then retrieving the logon information from the logon cookie;
e. providing a directory of users, the directory including an organization associated with each user, if any;
f. determining if an organization cookie is stored on the client system;
g. if the organization cookie is not stored on the client system, performing the steps of:
1. establishing an identity of the user as a function of the logon information;
2. querying the directory of users for the organization associated with the user; and,
3. writing the organization cookie to the client system;
h. if the organization cookie is stored on the client system, then determining the organization associated with the user as a function of the organization cookie;
i. determining access information as a function of the organization associated with the user;
j. granting access to one or more of the computer program applications as a function of the access information.

38. A method, as set forth in claim 36, including the step of providing a user access table, the user access table containing any access overrides for the users, wherein the step of granting access to one or more of the computer program applications includes the step of querying the user access table as a function of the identification of the user and establishing any access overrides for the user, and wherein the access is granted to the one or more of the computer program applications as a function of the access information and any access overrides.

39. A computer readable program product for providing access to a plurality of computer program applications through a server system to a user, the computer readable program product, comprising:
computer readable program code means for logging the user to the server system in response to logon information established by the user;
computer readable program code means for associating the user with an organization as a function of the logon information; and,
computer readable program code means for granting access to one or more of the computer program applications as a function of the organization associated with the user.

40. A computer readable program product for providing access to a plurality of computer program applications through a server system to a user, the computer readable program product, comprising:
computer readable program code means for logging the user to the server system in response to logon information established by the user;
computer readable program code means for associating the user with an organization as a function of the logon information;
computer readable program code means for determining access information as a function of the organization associated with the user;
computer readable program code means for determining any overrides as a function of the user; and,
computer readable program code means for granting access to one or more of the computer program applications as a function of the access information and the overrides associated with the user.

41. A system for providing access to a plurality of computer program applications to a user, comprising:
a client system for allowing the user to logon to the system by establishing logon information; and,
a server system, coupled to the client system by a communication link, for receiving the logon information from the client machine, associating the user with an organization as a function of the logon information, and granting access to one or more of the computer program applications as a function of the organization associated with the user.

42. A system, as set forth in claim 41, further comprising a directory of users, the directory including an organization associated with each user, if any.

43. A system, as set forth in claim 42, wherein the server system establishes an identity of the user as a function of the logon information and queries the directory of users for the organization associated with the user.

44. A system, as set forth in claim 43, wherein the directory of users is maintained in a database.

45. A system, as set forth in claim 44, wherein the database is a relational database.

46. A system, as set forth in claim 41, wherein the logon information is entered by the user.

47. A system, as set forth in claim 41, further comprising a client system connected to the system, wherein the user establishes the logon information using the client system.

48. A system, as set forth in claim 47, wherein the server system logs the user onto the system by determining if a logon cookie is stored on the client system in response to accessing a web page by the user and, if the logon cookie is stored on the client system, retrieving the logon information from the logon cookie.

49. A system, as set forth in claim 48, wherein the server system requests logon information from the user, if the logon cookie is not stored on the client system.

50. A system, as set forth in claim 49, wherein the server system writes the logon cookie onto the client system of the logon cookie was not previously stored on the client system.

51. A system, as set forth in claim 47, wherein the server system determines if an organization cookie is stored on the client system and retrieves the organization with which the user is associated from the organization cookie.

52. A system, as set forth in claim 51, further comprising a directory of users, the directory including an organization associated with each user, if any, and wherein the server system queries the directory of users for the organization associated with the user, if the organization cookie is not stored on the client system,

53. A system, as set forth in claim 52, wherein the server system writes organization cookie to the client system if the organization cookie was not previously written to the client system.

54. A system, as set forth in claim 41, further comprising a user access table, the user access table including any access overrides associated with the users.

55. A system, as set forth in claim 41, wherein the server system determines access information as a function of the organization associated with the user.

56. A system, as set forth in claim 55, wherein the server system grants access to the one or more computer program applications as a function of the access information.

57. A system, as set forth in claim 51, further including a user access table, the user access table containing any access overrides for the users; and wherein the server system queries the user access table as a function of the user and establishes any access overrides for the user.

58. A system, as set forth in claim 57, wherein the server system grants access as a function of the access information and any access overrides associated with the user.
